(19) United States
(12) Patent Application Publication
(10) Pub. No.: US 2017/0359094 A1
(43) Pub. Date: Dec. 14, 2017

(54) WIRELESS COMMUNICATION DEVICE INSIDE MANHOLE

(71) Applicant: Hyeong-Seo KOO, Ulsan (KR)

(72) Inventor: Hyeong-Seo KOO, Ulsan (KR)

(21) Appl. No.: 15/540,567

(22) PCT Filed: Jun. 24, 2015
(86) PCT No.: PCT/KR2015/006428

§ 371 Date: Jun. 28, 2017

(30) Foreign Application Priority Data
Dec. 29, 2014 (KR) 10-2014-0192000

(51) Int. Cl. H04B 1/38; G06F 3/14; E02D 29/14; G08C 17/02; G08B 21/16; G08B 21/20

(52) U.S. Cl. CPC H04B 1/38; G08B 21/16; G08B 21/20; E02D 29/14; G08C 17/02; G06F 3/14

(57) ABSTRACT

The present invention relates to a wireless communication device inside a manhole, comprising: a communication terminal installed inside a manhole; and an antenna extension cable connected to the communication terminal, wherein the antenna extension cable is electrically connected to a manhole cover of a conductive material which acts as an antenna so as to deliver a signal received from the manhole cover of a conductive material to the communication terminal. The wireless communication device inside a manhole is capable of delivering information regarding the inside of the manhole (equipment inspection, leakage check, etc.) to the outside without the manhole cover being opened. As such, it is possible to resolve traffic congestion caused by manhole check; control facilities inside the manhole without opening the manhole cover; by delivering opening and closing information of the manhole cover, prevent theft of the manhole and obviate safety accidents caused by the opening of the manhole cover; and prevent manhole worker safety accidents by monitoring the working environment during manhole work.

### TECHNICAL FIELD

The present invention relates to a wireless communication device inside a manhole that enables communication between the inside and outside of the manhole.

### BACKGROUND ART

A manhole is a facility that is designed to allow a person to go in and out of the facility to check or clean underground utilities, connect or join pipes, or do other work. In a pipeline, the manhole is installed at a starting point of a pipe, a confluence point of pipes, a position at which the diameter, direction or gradient of the pipeline changes, or a middle point of a long pipeline.

Manholes are often used for water supply and sewerage junctions and management of meters, communication lines, and electric lines, but it is difficult to monitor facilities inside a manhole. For example, it is difficult to install a communication cable for communication between the inside and outside of the manhole. Further, since the manhole housing is made of an iron material, it is impossible to communicate with the outside in a wireless manner, and it is impossible to confirm flooding therein without opening the manhole.

In addition, there are also the following problems in relation to prevention of manhole theft and accidents. That is, manhole covers are often stolen from isolated areas due to lack of resources. If a manhole is opened or damaged by vehicle traffic, there is a high risk of deadly consequences and accidents. In addition, since manholes are usually installed in the middle of the road, checking manholes is very likely to disturb traffic and cause accidents. Moreover, there are suffocation hazards during work inside the manhole.

### DISCLOSURE

### Technical Problem

Therefore, the present invention has been made in view of the above problems, and it is one object of the present invention to provide a wireless communication device inside a manhole which enables communication between the inside and outside of a manhole and is provided with various sensors (a gas sensor, a water leakage sensor, etc.) attached inside the manhole to transmit sensing information to the outside.

### Technical Solution

In accordance with one aspect of the present invention, provided is a wireless communication device inside a manhole, including:

a communication terminal installed inside the manhole, and an antenna extension cable connected to the communication terminal, wherein the antenna extension cable is electrically connected to a manhole cover of a conductive material serving as an antenna, and transmits a signal received from the manhole cover to the communication terminal.

Preferably, provided is a wireless communication device inside a manhole, including a communication terminal installed inside the manhole, an antenna extension cable connected to the communication terminal, and an antenna electrically connected to the antenna extension cable, wherein the antenna extension cable is inserted into a tube provided inside a manhole wall, and the antenna is arranged in a groove formed in a manhole housing contacting an outside, such that an external signal is transmitted to the communication terminal inside the manhole through the antenna extension cable.

In addition, the groove having the antenna inserted thereinto is coated or filled with a protective material containing one of silicone and glue to prevent the antenna from being damaged or water or foreign substances from infiltrating into the manhole.

Preferably, the wireless communication device further includes at least one of a gas sensor, a water leakage sensor and a manhole opening/closing sensor installed inside the manhole, and a display member electrically connected to the communication terminal and arranged so as to externally indicate a state of the manhole, wherein the communication terminal determines the state of the manhole based on sensing information from the gas sensor, the water leakage sensor, or the manhole opening/closing sensor, and displays the state through the display member.

### Advantageous Effects

According to embodiments of the present invention, information (instrument inspection, leakage check, etc.) about the inside of the manhole can be transmitted to the outside even without opening the manhole cover. Accordingly, traffic congestion caused by the manhole inspection can be addressed, and facilities inside the manhole can be controlled without opening the manhole cover. In addition, as information about the closed status of the manhole cover is communicated, manhole theft and accidents due to manhole cover opening may be prevented. Further, by monitoring the work environment during manhole work, manhole workers can be protected from accidents.

### DESCRIPTION OF DRAWINGS

FIG. 1A is a view showing a configuration of a manhole according to an embodiment of the present invention.

FIG. 1B is a view showing a configuration of a wireless communication device inside a manhole according to an embodiment of the present invention.

FIG. 2 is a view showing a configuration of a wireless communication device inside a manhole according to another embodiment of the present invention.

FIG. 3 is a view showing a wireless communication device inside a manhole according to another embodiment of the present invention.

### REFERENCE NUMERALS

101: Manhole cover
102: Manhole housing
103: Antenna
104: Antenna extension cable
105: Communication terminal
106: Display member

### BEST MODE

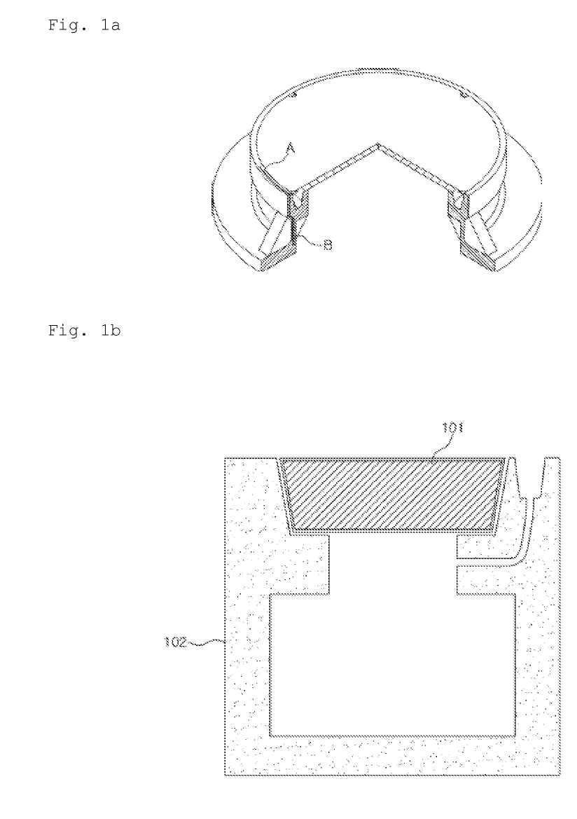

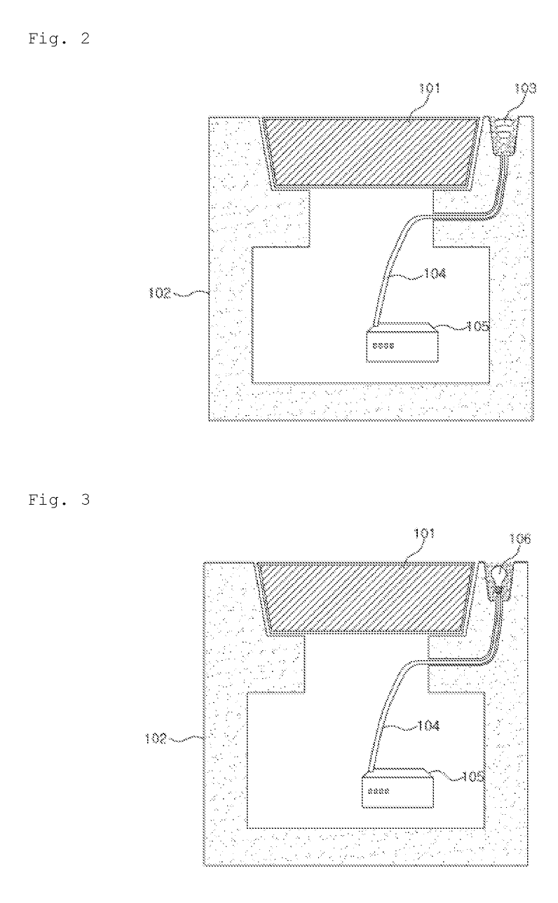

FIG. 1A is a view showing a configuration of a manhole according to an embodiment of the present invention, FIG. 1B is a view showing a configuration of a wireless communication device inside a manhole according to an embodiment of the present invention, and FIG. 2 is a view showing a configuration of a wireless communication device inside a manhole according to another embodiment of the present invention.

The first embodiment of the wireless communication device inside a manhole according to the present invention is a method of using a manhole as an antenna of a communication terminal for communication between the inside and outside of a manhole. The manhole may serve as an antenna for some frequencies since the communication terminal has an extension cable extending to the antenna and the cable is connected to the manhole, which is made of iron (for reference, a patent document forming the prior art discloses that wireless communication is performed between the inside and outside of a manhole, but, in reality, wireless communication is rarely possible since the manhole is surrounded by thick steel and concrete).

The specific structure of the first embodiment of the wireless communication device inside a manhole according to the present invention includes a communication terminal 105 installed inside the manhole, and an antenna extension cable 104 connected to the communication terminal 105. The antenna extension cable 104 is electrically connected to a manhole cover 101 made of a conductive material serving as an antenna, and serves to receive a transmitted signal through the manhole cover 101 of the conductive material (e.g., iron) and transmit the same to the communication terminal (battery-based wireless telecommunication terminal) 105.

As shown in FIGS. 1A and 2, a second embodiment of the wireless communication device inside a manhole according to the present invention is a method of inserting an antenna into a groove formed at the edge of the manhole to enable communication between the inside and outside of the manhole.

Of course, to protect the antenna from vehicles moving outside or foreign substances, the groove may be formed to be narrow and be covered with silicone or glue after the antenna is inserted thereinto. This would prevent water or foreign substances from infiltrating into the manhole as well as the antenna.

In manufacturing the manhole, a tube is inserted into the manhole wall, the antenna extension cable B is inserted into the tube, and a long groove is formed in the manhole housing, which contacts the outside, such that the antenna A having a predetermined length is laid down and installed in the groove (see FIG. 1A).

Specifically, the wireless communication device includes a communication terminal 105 installed inside the manhole, an antenna extension cable 104 connected to the communication terminal 105, and an antenna 103 electrically connected to the antenna extension cable 104. The antenna extension cable 104 is inserted into a tube installed inside the manhole wall, and the antenna 103 is arranged in a groove formed in a manhole housing 102 contacting the outside, such that an external signal is transmitted to the communication terminal 105 inside the manhole through the antenna extension cable 104 (see FIG. 2).

The antenna 103 is protected or infiltration of water or foreign substances into the manhole is prevented by coating or filling the groove with a protective material including any one of silicone and glue after the antenna 103 is inserted into the groove.

FIG. 3 is a view showing a wireless communication device inside a manhole according to a third embodiment of the present invention.

As shown in FIG. 3, the third embodiment of the wireless communication device inside a manhole according to the present invention includes at least one of a gas sensor, a water leakage sensor and a manhole opening/closing sensor installed inside the manhole. The wireless communication device also includes a display member (e.g., LED) 106 that is electrically connected to the communication terminal (through a power cable) and arranged so as to externally indicate the state of the manhole. The communication terminal 105 determines the state of the manhole based on the sensing information from the gas sensor, the water leakage sensor, or the manhole opening/closing sensor, and displays the state through the display member 106.

For example, in at least one of a case when the amount of gas sensed by the gas sensor is greater than or equal to a predetermined gas amount, a case when the amount of water leakage sensed by the water leakage sensor is greater than or equal to a predetermined water leakage amount, and a case when the manhole is opened, the communication terminal 105 determines that the manhole is in an abnormal state, and causes an LED lamp of a color indicating the abnormal state to be turned through the display member 106. If only one LED lamp is provided, the communication terminal 105 simply causes the LED lamp to be turned on.

On the other hand, in at least one of a case when the amount of gas sensed by the gas sensor is less than the predetermined gas amount, a case when the amount of water leakage sensed by the water leakage sensor is less than the predetermined water leakage amount, and a case when the manhole is closed, the communication terminal 105 determines that the manhole is in a normal state, and causes an LED lamp of a color indicating the normal state to be turned on. If only one LED lamp is provided, the communication terminal 105 simply causes the LED lamp to be turned off.

### INDUSTRIAL APPLICABILITY

The present invention is applicable to a wireless communication device inside a manhole that enables communication between the inside and outside of a manhole.

1. A wireless communication device inside a manhole, comprising:
a communication terminal installed inside the manhole; and
an antenna extension cable connected to the communication terminal,
wherein the antenna extension cable is electrically connected to a manhole cover of a conductive material serving as an antenna, and transmits a signal received from the manhole cover to the communication terminal.

2. A wireless communication device inside a manhole, comprising:
a communication terminal installed inside the manhole;
an antenna extension cable connected to the communication terminal; and
an antenna electrically connected to the antenna extension cable,
wherein the antenna extension cable is inserted into a tube provided inside a manhole wall, and the antenna is arranged in a groove formed in a manhole housing contacting an outside, such that an external signal is transmitted to the communication terminal inside the manhole through the antenna extension cable.

3. The wireless communication device according to claim 2, wherein the groove having the antenna inserted thereinto is coated or filled with a protective material containing one of silicone and glue to prevent the antenna from being damaged or water or foreign substances from infiltrating into the manhole.

4. The wireless communication device according to any one of claims 1 to 3, further comprising:
at least one of a gas sensor, a water leakage sensor and a manhole opening/closing sensor installed inside the manhole; and
a display member electrically connected to the communication terminal and arranged so as to externally indicate a state of the manhole,
wherein the communication terminal determines the state of the manhole based on sensing information from the gas sensor, the water leakage sensor, or the manhole opening/closing sensor, and displays the state through the display member.
